(19) United States
(12) Patent Application Publication
(10) Pub. No.: US 2009/0266397 A1
(43) Pub. Date: Oct. 29, 2009

(54) SOLAR BATTERY CHARGING SYSTEM AND OPTIONAL SOLAR HYDROGEN PRODUCTION SYSTEM FOR VEHICLE PROPULSION

(75) Inventors: Thomas L. Gibson, Utica, MI (US); David B. Ouwerkerk, Torrance, CA (US); Nelson A. Kelly, Sterling Heights, MI (US); Ian J. Sutherland, Grosse Pointe, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., DETROIT, MI (US)

(21) Appl. No.: 12/107,857

(22) Filed: Apr. 23, 2008

(51) Int. Cl. H02N 6/00; H01M 10/44

(52) U.S. Cl. 136/244; 320/101

(57) ABSTRACT

A product includes a vehicle battery, capable of being charged using solar energy, a plurality of photovoltaic cells, arranged in at least one of series or parallel, forming an array that produces a self-regulated voltage and current for charging the vehicle battery using solar energy, and an electrical connection linking the array to the vehicle battery.

### TECHNICAL FIELD

The field to which the disclosure generally relates includes solar energy battery chargers and electrolytic hydrogen production.

### BACKGROUND

Currently, transportation is overwhelmingly dependent on fossil fuels which contribute to greenhouse gas emissions and raise concerns over future energy costs, energy security, and environmental impact. Harnessing solar energy using a more efficient and cost effective system to charge batteries and produce hydrogen can help reduce fossil fuel usage, regulated pollutant emissions, and greenhouse gas emissions including carbon dioxide.

### SUMMARY OF EXEMPLARY EMBODIMENTS OF THE INVENTION

In one embodiment, a product is provided that includes a vehicle battery capable of being charged using solar energy, a plurality of photovoltaic cells, arranged in series, parallel, or both series and parallel, forming an array that produces a self-regulating voltage or current for charging the vehicle battery using solar energy, and an electrical connection linking the array to the vehicle battery.

In another embodiment, a product is provided that includes a battery capable of being charged with solar energy, a plurality of photovoltaic cells arranged in series, parallel, or series and parallel according to the voltage and power of each photovoltaic cell, forming an array capable of charging the battery, where the voltage and current generated by the array are controlled by the charge of the battery, and an electrical connection linking the array to the battery.

In another embodiment, a product is provided that includes a plurality of photovoltaic cells, arranged in series, parallel, or series and parallel forming an array that produces a self-regulating voltage or current for charging the vehicle battery using solar energy, a first battery capable of storing electric energy generated by the plurality of photovoltaic cells, where the first battery is substantially stationary, a first link electrically connecting the plurality of photovoltaic cells and conveying the self-regulating voltage or current from the plurality of photovoltaic cells to the first battery, a second battery mounted on a vehicle capable of receiving charge from the first battery, and a second link electrically connecting the first battery and the second battery where the first battery applies a charge to the second battery through the second link.

In another embodiment, a product is provided that includes an array of photovoltaic cells capable of charging a vehicle battery arranged in series, parallel, or series and parallel according to the voltage and power of each photovoltaic cell, wherein the array produces a maximum power point voltage that substantially equals a set point voltage of the vehicle battery, a first battery remaining in a substantially stationary position capable of receiving a charge from the array, a second battery mounted in a vehicle capable of receiving a charge from the first vehicle battery, an electrolyzer for producing hydrogen, wherein the hydrogen is stored in tanks either adjacent to the electrolyzer or on the vehicle, and a control system for selectively directing the energy generated by the array to the first battery, the second battery, the electrolyzer, or an electric grid.

In another embodiment, a method is provided that includes determining a set point voltage of a vehicle battery, calculating a photovoltaic power to charge the vehicle battery, establishing the number of photovoltaic cells to be electrically connected in series by determining the maximum power point voltage per photovoltaic cell and dividing the set point voltage by the maximum power point voltage per photovoltaic cell, establishing the number of photovoltaic cells to be electrically connected in parallel by determining the photovoltaic power per cell and dividing the photovoltaic power by the photovoltaic power per cell, arranging a plurality of photovoltaic cells in an array according to the established number of photovoltaic cells in series and the established number of photovoltaic cells in parallel, and electrically linking the array to the vehicle battery in order to charge the vehicle battery to the set point voltage using solar energy.

In another embodiment, a method is provided that includes determining a set point voltage of a vehicle battery, determining an operating voltage of an electrolysis system, calculating a photovoltaic power for charging the vehicle battery and generating hydrogen, and forming an array of photovoltaic cells arranged in series, parallel, or series and parallel according to the set point voltage of the vehicle battery and the operating voltage of an electrolysis system.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 shows a charging system according to one embodiment of the invention;

FIG. 2 shows a charging system according to one embodiment of the invention;

FIG. 3 shows the estimated weight of various battery packs according to one embodiment;

FIG. 4 is a graph of current and voltage versus time for a photovoltaic array charging a battery pack according to one embodiment;

FIG. 5 is a graph of estimated charge rate versus time for a photovoltaic array system charging a battery pack according to one embodiment;

FIG. 6 shows a charging system according to one embodiment of the invention;

FIG. 7 shows a charging system according to one embodiment of the invention;

FIG. 8 shows a charging system according to one embodiment of the invention; and

FIG. 9 shows a charging system according to one embodiment of the invention.

### DETAILED DESCRIPTION OF EXEMPLARY EMBODIMENTS

The following description of the embodiments is merely exemplary in nature and is in no way intended to limit the invention, its application, or uses. As previously mentioned, the product described herein generally includes an array of photovoltaic (PV) cells that generate solar energy and are electrically linked to a rechargeable battery capable of receiving charge from the generated solar energy. Once charged, the battery may be used to power a vehicle such as an extended range electric vehicle (EREV). Such a vehicle may also be referred to as a plug-in hybrid vehicle, an electric vehicle, or any other vehicle not relying solely on energy generated on board the vehicle by an internal combustion engine. The array of PV cells (wherein the term PV cells can be used interchangeably with the term PV modules) may be designed in response to the voltage and power characteristics desired from the battery. More specifically, knowing the voltage and power characteristics of the battery and the voltage and power characteristics of a plurality of PV cells, a designer may organize and link the plurality of PV cells, in series or parallel, into an array producing a maximum peak power voltage that is substantially equal to a set point voltage (recommended charging voltage) of the battery. This arrangement may provide a self-regulating charging system. For instance, depleted batteries directly linked to the array will receive an appropriate amount of current that decreases as battery voltage increases, as can be appreciated from the current-voltage relationship in the system.

PV cells capture energy from light or sunlight and convert light energy into electrical energy. Sometimes the term solar cell is reserved for devices intended specifically to capture energy from sunlight, while the term photovoltaic cell is used when the light source is unspecified. Either cell may be used with this system. PV cells effect the photogeneration of charge carriers in a light-absorbing material and the carrying of the charge carriers to a wire or circuit that transmits the electricity. This conversion is called the photovoltaic effect. As mentioned previously, PV cells may be arranged in an array, by linking the PV cells in series and/or in parallel, in order to produce power, voltage, or current characteristics as desired by a system. The array could take the form of a variety of configurations and the form will depend on the power, voltage, or current needs of the system. Some examples of presently available PV cells are Sharp NT-186U1 modules and Sanyo HIP-190BA3 modules.

Batteries used in conjunction with the previously mentioned product and method can be any battery having the ability to be returned to a full charge by the application of electrical energy. The batteries should also be able to accept the application of electrical energy generated from PV cells or modules. Batteries may be designed to remain stationary or be removably connected to a vehicle. Many different battery designs may be employed with the present system. Some examples of battery designs include Lithium-Ion (Li-Ion), Nickel-Metal Hydride (NiMH), and Lead Acid. Battery choices may be influenced by weight, size, and cost considerations. For example, the weight of a 16-kWh battery can be estimated from the reported energy densities of the various types of batteries shown in FIG. 3. The actual gravimetric energy densities for the aforementioned battery designs can be Li-Ion, 125 Wh/kg; NiMH, 70 Wh/kg; and Lead Acid, 36 Wh/kg. Thus, Lithium-Ion technology may reduce the weight of a battery pack to approximately one quarter the weight of a Lead Acid battery having an equivalent capacity. Since weight reduction of a vehicle generally reduces vehicle energy use, the use of Lithium-Ion batteries used in conjunction with an EREV may reduce the energy required for the vehicle to function.

Since it is envisioned that a battery can be fixed in an EREV or removable from a vehicle in modular form, reduced weight and size can also ease the effort required to load, unload, or move a battery. To make the switching of a removable battery easier, a cart using a lever-driven sliding tray to manually raise, lower, or shift a battery for installation on a vehicle may be provided to assist consumers in removing and replacing the batteries in a vehicle between use cycles. The cart may also be effectuated by a motor driven transfer system.

It should also be appreciated that the PV array may be electrically connected to other devices. For instance, the PV array may be linked to a switch or control system having multiple outputs. Instead of powering the battery, the switch or control system may be controlled to cause the PV array to provide power to an electrolyzer which in turn converts water into hydrogen and oxygen components. The hydrogen can be then directed to high-pressure storage tanks located either on the vehicle or near the PV array. Alternatively, if the battery is fully charged and the hydrogen storage tanks are filled, or if the user requires it, the switch or control system connected to the PV array may be controlled to provide power to a building or structure normally connected to an electrical utility grid.

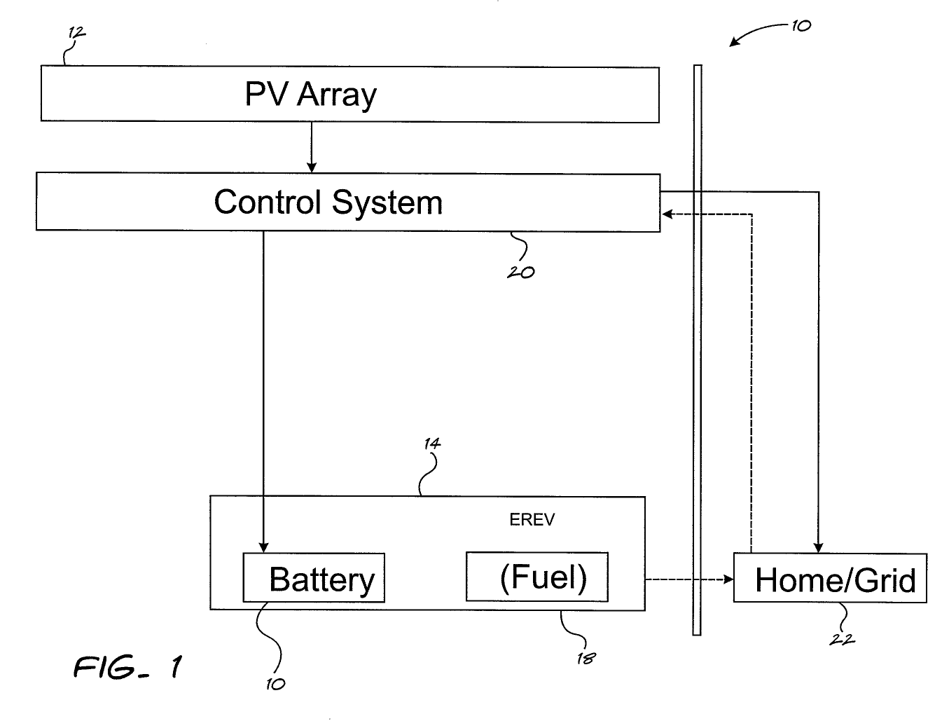

FIG. 1 shows a general embodiment of a solar battery charging system generally speaking 10. Included in the system 10 is a PV array 12, an EREV 14 that includes a battery 16 and fuel 18, a control system 20, and a building/electric grid 22. The control system 20 may be a single switch, an implementation of logic controls, or any other suitable control system. Fuel 18 may be hydrogen, fossil fuel, or any other propulsion fuel capable of powering a vehicle. Ultimately, the PV array 12 generates a voltage and current, each dependent on the design of the PV array 12. The EREV 14 carries a battery 16 and fuel 18 for propulsion. Linking the PV array 12 and the EREV 14 is the control system 20. The control system 20 also is capable of directing voltage and current generated by the PV array 12 to the home or electrical grid 22.

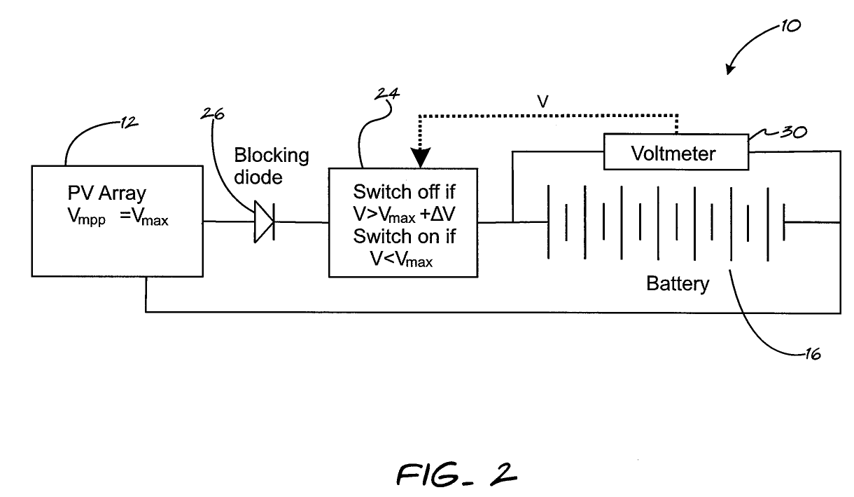

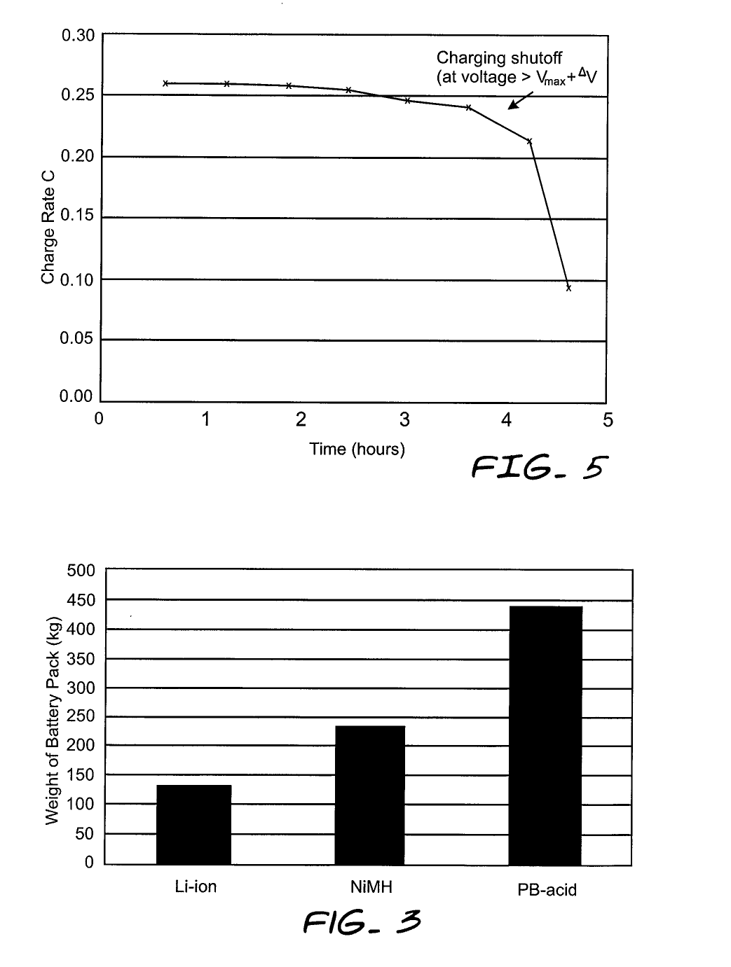

Turning to FIG. 2, one embodiment of the solar battery charging system 10 is shown that includes a photovoltaic (PV) array 12, a battery 16, a switch 24, a blocking diode 26, and a sensor 30, such as a voltmeter. The system 10 may use the switch 24 and the diode 26 to regulate current between the PV array 12 and the battery 16. Simpler charging systems may be constructed by omitting the switch 24 and blocking diode 26 and electrically linking the battery 16 directly to the PV array 12. While the system 10 described here can be used in association with an extended range electric vehicle (EREV), it can be appreciated that the charging system 10 may also be used with any suitable battery 16 capable of accepting a charge generated from light energy. The battery 16 shown in FIG. 2 is designed to be removable from an EREV and recharged using solar energy generated from the PV array 12. In this embodiment, the PV array 12 may be electrically connected to the battery 16 and the power from the PV array 12 may flow directly to the battery 16. Alternatively, the battery 16 may remain in an EREV and recharge using the PV array 12. The battery 16 is represented in FIG. 2 by seven cells in series, but the number of cells in the battery 16 and their arrangement in various embodiments of the invention are determined according to the voltage and power needs of the vehicle as described below.

The PV array 12 is constructed with an arrangement of PV cells, connected in parallel and/or series, producing the optimum power, voltage, or current for charging the battery 16. The battery 16, such as a battery using a Li-Ion design, usually has a set point voltage (Vₘₐₓ). The set point voltage of the battery 16 may be a pre-set voltage value considered optimum and determined to provide the best tradeoff between performance and longevity. This tradeoff may be appreciated from Table 1 below. Some common types of Li-Ion batteries use a set point voltage value of 4.2 volts per cell, but set point voltages may vary depending on the application and the type of the Li-Ion cells. Other cells can have different voltages. One type of Li-Ion cell with an iron phosphate cathode can have an operating voltage of 3.3 volts and a set point voltage of 3.6 volts. In various embodiments, other types of cells including NiMH and lead acid may be used.

After determining the set point voltage of each battery cell, cells are arranged in series and/or parallel to generate a desired voltage. For example, the battery 16 may be required to provide enough energy to power an EREV for 40 miles on battery power alone. Potentially, the battery 16 having a voltage of 340 volts may be designed to fulfill this requirement. Using the ideal set point voltage of 4.2 volts described above, 81 cells can be used in series to generate 340 volts. However, using a different Li-Ion cell with an iron phosphate cathode having a set point of 3.6 volts, 95 cells would be used in series to generate 342 volts. Knowing the ideal set point voltage and amperage of the battery 16, it is possible to design a PV array system 12 that has a maximum power point voltage (Vₘₚₚ) equal to the set point or full charge voltage (Vₘₐₓ) of the battery 16.

When designing the PV array 12, it is helpful to calculate the operating power point voltage of each PV cell or module. At an operating temperature of 55° C., 54.8 volts—[(169 mV/° C.)×(55°-25° C.)]/1000 mV/V equals 49.7 V per module (assuming that Sanyo HIP-190BA3 modules are used). Dividing the battery voltage (340 V) by the voltage of each PV cell or module (49.7 V) indicates that 7 modules electrically linked in series would produce a maximum power point voltage (Vₘₚₚ) substantially equal to the set point or full charge voltage (Vₘₐₓ) of the battery 16. Once the maximum power point voltage (Vₘₚₚ) of the PV array 12 is calculated to be substantially equal to the set point or full charge voltage (Vₘₐₓ) of the battery 16, the desired power of the PV array 12 may be determined. Referring to Table 1, it can be appreciated that at a set point voltage of 4.2 volts per cell, a current of 6.9 amps may be produced.

TABLE 1

| | | Battery | | | Charge | Charge | | | |
|---|---|---|---|---|---|---|---|---|---|
| Time | Volts per | pack | Current | | increment | increment | Charge | Charge | Charge |
| (hours) | battery cell | voltage | (amps) | P (kW) | (Ah) | (kWh) | (Ah) | (kWh) | rate C |
| 0 | 2.5 | 203 | 7.56 | 1.5 | 0 | 0 | 0 | 0 | 0 |
| 0.6 | 2.61 | 211 | 7.56 | 1.6 | 4.54 | 0.94 | 4.5 | 0.94 | 0.25 |
| 1.2 | 3.06 | 248 | 7.56 | 1.9 | 4.54 | 1.04 | 9.1 | 1.98 | 0.25 |
| 1.8 | 3.49 | 283 | 7.5 | 2.1 | 4.52 | 1.20 | 13.6 | 3.18 | 0.25 |
| 2.4 | 3.86 | 313 | 7.33 | 2.3 | 4.45 | 1.32 | 18.0 | 4.50 | 0.24 |
| 3 | 4.1 | 332 | 7.15 | 2.4 | 4.34 | 1.40 | 22.4 | 5.90 | 0.24 |
| 3.6 | 4.2 | 340 | 6.94 | 2.4 | 4.23 | 1.42 | 26.6 | 7.32 | 0.23 |
| 4.2 | 4.21 | 341 | 5.6 | 1.9 | 3.76 | 1.28 | 30.4 | 8.60 | 0.21 |
| 4.6 | 4.21 | 341 | 0 | 0.0 | 0 | 0 | 30.4 | 8.60 | 0 |

Using the voltage in our example (340 V), multiplied by the amperage of the battery 14 at the desired set point voltage (6.9 A), the amount of power the PV array 12 in our example should generate may equal approximately 2.4 kW. To calculate the power of the PV array 12, it is sometimes helpful to compensate for power loss due to the effect of temperature. For instance, if the PV array 12 lost 0.30% of its power per temperature degree above 25° C. and a typical operating temperature may be 55° C., the PV array 12 may be designed to compensate for a 9% loss of power. In our example, 2.4 kW multiplied by the inverse of 1.09 indicates that the PV array 12 should be designed to generate approximately 2.6 kW under standard test conditions of 1000 W/m² solar radiation at 25° C. in order to compensate for the power loss of operating 30 degrees above 25° C. The aforementioned PV cells in our example may be rated to produce 190 W. Dividing the power requirements (2.6 kW) by the power per PV module or cell (190 W) indicates that 14 PV cells or modules may be used in the PV array 12. Therefore in this example, the PV array 12 would use two strings, each having 7 PV modules electrically linked in series, with the two strings electrically linked in parallel.

Designing the PV array 12 in this manner provides an electrical voltage and current generated from light energy that can be directly linked to the battery 16 and drawn from the array 12. Thus, a solar powered PV array 12 can take the place of a utility grid (AC) powered conventional battery charger and directly generate the necessary DC current to charge the DC battery 16 used to propel a vehicle. The design of the charging system 10 illustrated in FIG. 2 may be self regulating based on the choice of PV cells or modules and their wiring configuration in the design. This arrangement provides a system 10 that may require much less regulation of current or voltage than battery chargers using only a charge control device to regulate the flow of current.

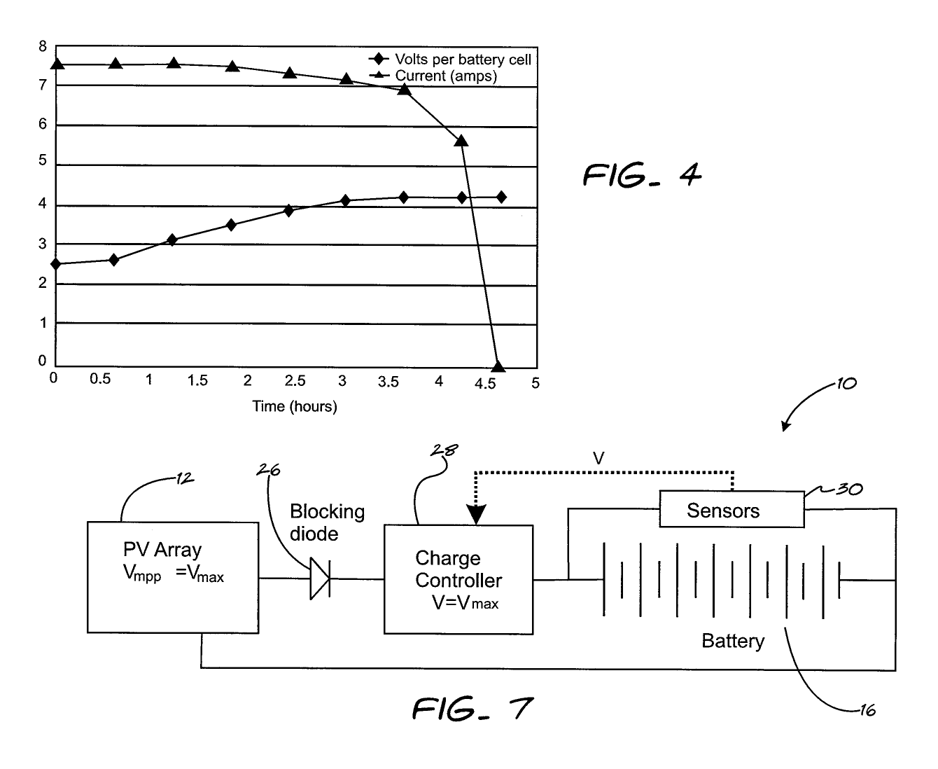

The self regulating qualities of the PV array 12 may produce a high constant current at whatever voltage the battery 16 demands, such as the voltage measured between the battery terminals, from the low starting voltage (discharged state) up to the set point voltage. The maximum current output of the PV array 12 may be delivered to the battery 16 as long as the voltage of the battery 16 is at or below the set point voltage (Vₘₐₓ) and the maximum power point voltage of the PV array 12. When the battery 16 becomes fully charged or if the voltage rises above the set point voltage (Vₘₐₓ) the current will begin to sharply decrease above the PV maximum power point voltage (Vₘₚₚ) because of the natural shape of the current-voltage (I-V) curve of PV power systems. This relationship may be a result of designing the PV array 12 with Vₘₚₚ substantially equal to Vₘₐₓ of the battery 16. Thus, the natural photovoltaic current-voltage (I-V) curve optimizes the charge rate. FIG. 4 illustrates a simulated current-voltage versus time curve for the PV array system 12 charging a battery pack 16 while FIG. 5 shows an estimated charge rate, which is approximately 0.25 C (a moderate charge) due to the moderate power and long charge time chosen for the PV array 12 design.

The system 10 described in this embodiment, as shown in FIG. 2, charges the battery 16 without the use of a DC-DC converter or a charge control device. But control of the system 10 may be effectuated using the switch 24, the blocking diode 26, and the sensor 30, such as a voltmeter. The design of this system 10 may minimize resistance losses and cost. Additionally, the current generated by the PV array 12 may be limited by the capacity of the PV array 12 to less than the maximum recommended by the battery manufacturer, which prevents any damage to the battery 16. The maximum charge rate allowed by the manufacturer is usually 1C, a charge rate equivalent to charging a completely discharged battery to a full charge in one hour. In one embodiment, the maximum current or ampacity of the charging system 10 has current below 8 ADC maximum with relatively high voltage, greater than 200 VDC. Therefore, copper wiring rated AWG 4 usually will be sufficient to assure <1% efficiency losses assuming that the distance to the PV array 12 is less than 50 feet. Wire size may be chosen in each installation to make sure the losses are <1% by using the National Electrical Code tables for the operating conditions.

Referring again to FIG. 2, the switch 24, located between the battery 16 and PV array 12, may be activated when the battery 16 reaches full charge or the battery 16 has reached its set point voltage. A voltage cut-off occurs after the voltage measured at the terminals of the battery 16 exceeds the set point voltage, Vₘₐₓ, plus ΔV of the battery 16, where the permissible tolerance of ΔV may equal the number of battery cells times approximately 50 mV. Or the voltage cut-off can occur at any predetermined voltage value. For example, using 81 battery cells with a Vₘₐₓ of 4.2, ΔV may equal 81 multiplied by 0.05 V resulting in a ΔV of 4 volts for a battery 16 having a voltage of approximately 340 V. This ΔV of 4 V per pack or a similar additional voltage may be included to boost the capacity of the battery 16 but risks lowering the battery pack's cycle life (the number of charges and discharges before failure). The initial extra voltage ΔV may drop slightly after the charging current is cut-off. If the battery voltage drops below Vₘₐₓ, or any predetermined voltage value current may be allowed to pass again by the switch 24 to maintain the battery charge between Vₘₐₓ and Vₘₐₓ plus ΔV. Charging resumes if the voltage of the battery 16 drops below Vₘₐₓ while the charging system 10 is still connected to the battery 16. The blocking diode 26, such as a zener diode, prevents current discharge from the battery 16 to the PV array 12 under low light conditions. A fully charged battery 16 may be taken off the charging system 10 and inserted in a vehicle soon after charging is complete.

When the battery 16 is not completely charged by the solar energy available on short or cloudy days, the consumer could use a plug-in charger provided with a vehicle to top off the charge using AC power from the utility grid. The calculations herein use the average solar energy recorded in Detroit (4.2 peak sun hours where a PSH is 1 kW h/m²) to estimate the power and size of the PV array system 12. Each PV powered charging system 10 could be designed for the specific site where it is to be used, for example using PV energy tables for various locations in the United States published by the National Renewable Energy Laboratory.

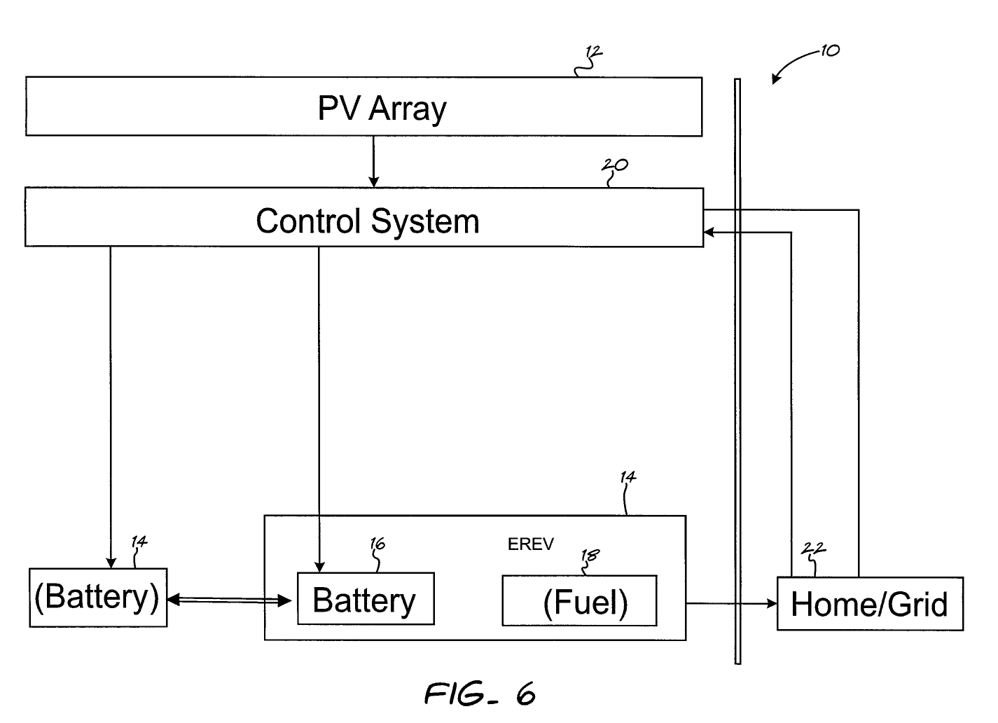

As can be appreciated in FIG. 6, one embodiment encompasses the charging system 10 using a removable battery 16 that may be removable from a vehicle or EREV 14 with the aid of the aforementioned cart. After removing the battery 16 from the vehicle or EREV 14, the battery 16 may be electrically linked to a substantially stationary charging system 10 located at a user's home or office. At this time the EREV 14 could remain stationary near the charging system 10 until the removable battery 16 is charged by the charging system 10. Alternatively, two removable batteries 16 may be used and the charging system 10 can charge one battery 16 while another battery 16 is used in the EREV 14. When the user desires a fully-charged battery 16, the user may remove a depleted battery 16, and electrically link it to the charging system 10 while removing a fully-charged battery 16 from the charging system 10 and loading it on the EREV 14.

In one embodiment, the charging system 10 may be used by drivers who usually or for certain periods commute to and/or from work at night, in which case neither a second interchangeable battery 16 nor equipment to help insert the battery 16 in the EREV 14 would be needed. The battery 16 may be charged in the vehicle or EREV 14 using the charging system 10 via a plug-in connection to the battery 16 on the outside of the vehicle or EREV 14. The charging system 10 could be plugged into the EREV 14 in the morning and left all day to charge the battery 16 in preparation for night commuting. The capital cost of the system 10 may be reduced without using a second battery 16 or removal cart. It is also envisioned that the PV array 12 in this embodiment could be located at the user's workplace if the EREV 14 is typically stationary at the workplace during daylight hours.

Referring to FIG. 7, in one embodiment a more sophisticated solar charging system 10 is provided. The charging system 10 may provide optimum charging conditions and further protect battery life by including a charge control device 28 using a charge regulator and sensors 30 connected to the battery 16 to actively control the charge rate and set point voltage of the battery 16.

In this embodiment, power from the PV array 12 flows to the battery 16 through the charge control device 28. The charge control device 28 may include a DC-DC converter including a solid state inverter, a transformer, a rectifier, and/or a charge regulator. In one embodiment, the voltage of the PV array 12 with a voltage input greater than 150 volts (for example, as high as 450-600 volts) to the charge control device 28 may be stepped down to the voltage of the battery 16 (for example, 320-350 volts) during charging while the PV array current output is increased (for example, from 4 to 9 amps) to increase the charge rate. In one embodiment, this may be accomplished in several steps. First, the DC power from the PV array 12 is converted to AC by the low-frequency (60 cycle) solid state inverter. Then, the AC voltage is stepped down by the transformer and converted to the desired DC power by the rectifier. In one embodiment, there may be an approximately 8% or greater loss of power and efficiency due to greater resistances in the controller circuitry compared to the direct connection controller generally shown in FIG. 1.

In one embodiment, the charge control device 28 may also optimize the battery charge rate. To optimize charging, the charge control device 28 senses that the battery voltage is below the set point voltage and maximizes the initial current and charge rate by forcing voltage higher during a first phase of charging named the current limit phase. When the voltage reaches the set point Vₘₐₓ of the battery 16, a second phase of charging may begin named the constant-voltage phase. This phase may begin when the charge control device 28 reduces the charging current as necessary to hold the voltage (measured at the terminals of the battery 16) constant at Vₘₐₓ to achieve a full charge.

When the charge control device 28 senses that the battery 16 has reached full charge, voltage from the PV array 12 may be shut off. The charge control device 28 can cut off voltage after the voltage of the battery 16 measured at the battery terminals exceeds the set point voltage, Vₘₐₓ, of the battery 16 (for example, 320-350 volts) plus ΔV of the battery pack 16. The permissible tolerance ΔV may equal the number of battery cells times about 50 mV (for example, 320-350 volts plus a ΔV of 4 volts for an 81-cell battery pack). In one embodiment, a circuit may be used such that the charger is shut off if the charge current drops below a set limit, such as 3% of the maximum current.

In one embodiment, additional protection circuits (voltage and temperature sensors) that limit the battery pack to Vₘₐₓ+0.10 volt/cell and 90° C. may be built into the battery 16 or the charge control device 28 to shut off charging if these limits are exceeded to prevent overcharging. Blocking diodes 26 prevent current discharge from the battery 16 to the PV array 12.

Battery charging using the charging system 10 as shown in FIG. 7 was approximated by models based on the characteristics of one typical PV system 12 and typical charge control device 28. The results are shown in Table 2 below, where the Lithium-Ion battery pack had 81 cells in series, and the PV array 12 was at 1000 W/m² and 55° C. The high efficiency, Sanyo HIP-190BA3 modules, had 16.7% module efficiency, 172.9 Watts power, Vₘₚₚ of 49.7 volts, and Iₘₚₚ of 3.48 amps. The charging system contained 12 Sanyo modules in series to give a Vₘₚₚ of 596 volts, which is then stepped down to 340 volts.

TABLE 2
PV modules: Sanyo HIP-190BE3

| | | | | Charge | | | |
|---|---|---|---|---|---|---|---|
| Time | volts/ | Volt- | Current | increment | Charge | Charge | Charge |
| (hours) | cell | age | (amps) | (kWh) | (Ah) | (kWh) | rate C |
| 0 | 2.5 | 203 | 9.4 | 0.0 | 0.0 | 0.0 | 0.17 |
| 0.6 | 2.6 | 211 | 9.0 | 1.1 | 5.4 | 1.1 | 0.33 |
| 1.2 | 3.1 | 248 | 7.7 | 1.2 | 10.0 | 2.3 | 0.30 |
| 1.8 | 3.5 | 283 | 6.8 | 1.2 | 14.1 | 3.4 | 0.26 |
| 2.4 | 3.9 | 313 | 6.1 | 1.1 | 17.8 | 4.6 | 0.23 |
| 3 | 4.1 | 332 | 5.7 | 1.1 | 21.2 | 5.7 | 0.21 |
| 3.6 | 4.2 | 340 | 5.6 | 1.1 | 24.6 | 6.9 | 0.20 |
| 4.2 | 4.2 | 341 | 5.6 | 1.1 | 27.9 | 8.0 | 0.20 |
| 4.6 | 4.2 | 341 | 0 | 0 | 27.9 | 8.0 | 0 |

Electrical resistance in the charge controller 28 caused an 8% loss of power as shown in Table 2.

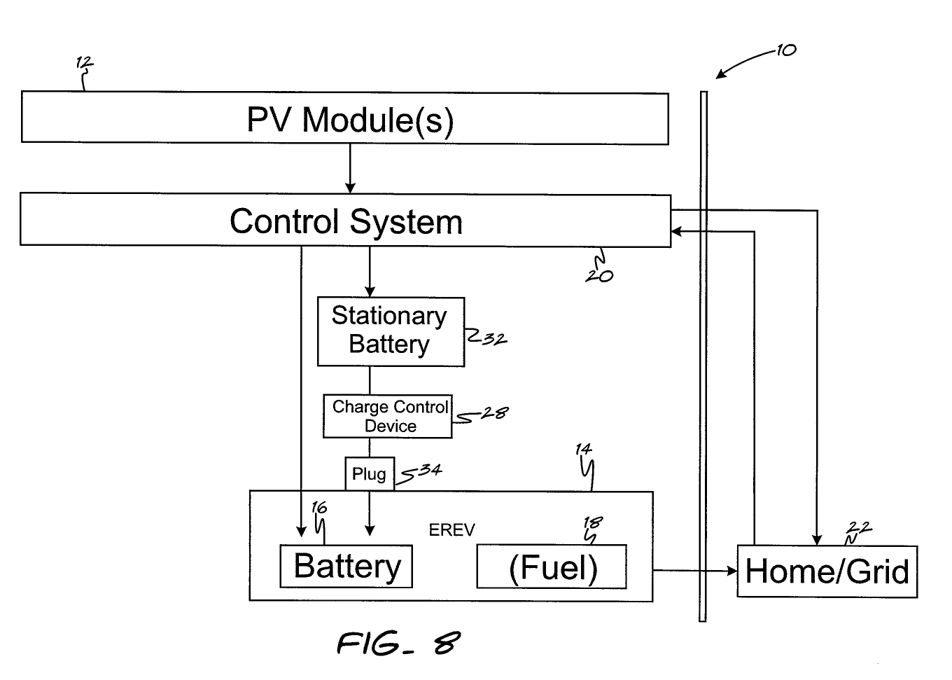

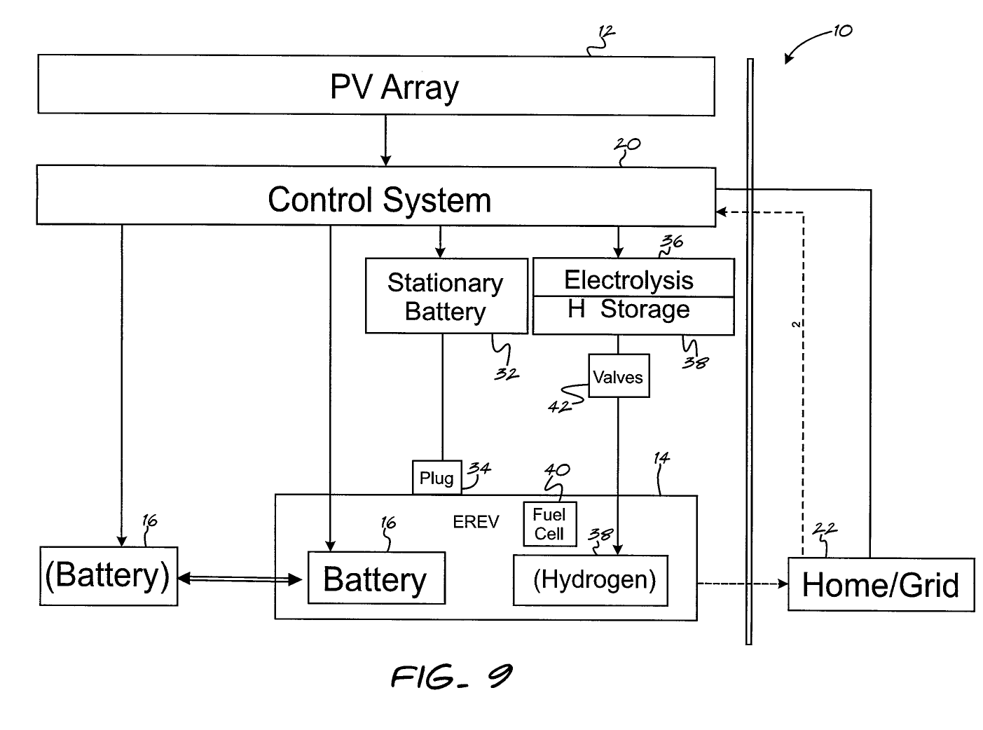

Referring to FIG. 8, another embodiment is provided to store solar power from PV arrays 12 and use it to recharge a battery 16 mounted in an EREV 14. Some consumers might prefer an alternative to replacing a discharged battery 16 with a freshly charged battery 16, even considering the special changing tools that could be provided. During the daylight hours, the PV array 12 could be used to charge a stationary storage battery 32. PV power from the PV array 12 would flow into the stationary storage battery 32 kept in a charging location, for example a garage, through a charge control device 28 containing a DC-DC converter and a charge regulator. When a user desired to charge his vehicle or EREV 14, he would electrically link the battery 16 to the stationary battery 32 through a plug 34 and a charge control device 28. As described in a previous embodiment, a blocking diode 26 could be used to help maintain the charge contained in the stationary storage battery 32.

In one embodiment, the capacity of the stationary storage battery 32 may be at least 1.35 times greater than the capacity of the battery 16 to be charged in the EREV 14. Additionally, it is possible to construct a stationary storage battery 32 from a plurality of batteries 16 that no longer possess charge characteristics suitable for use in a vehicle and wire them in parallel. The PV voltage and current inputs to the control system 20 or charge control device 28 may be adjusted to the voltage and current required for optimum battery charging as described above. In one embodiment, there may be total power and efficiency losses of 16% or greater compared to the direct connection embodiment as shown in FIG. 1. These losses may be due to greater total resistance in one pass through a control system 20 and one pass through the charge control device 28 to convert PV power to a lower DC voltage and regulate the charge rates of the stationary storage battery 32 and vehicle battery 16. In this embodiment, the control system 20 may use and carry a plurality of charge control devices 28.

The stationary storage battery 32 may be charged using a PV array 12 as described in a previous embodiment. To charge the battery 16 installed inside a vehicle or the EREV 14, the stationary storage battery 32 may be connected through the charge control device 28 to a plug or receptacle 34 electrically attached to battery 16 on the EREV 14. The charge control device 28 limits the charge rate of the battery 16 (using a timer, chopper, or other means) to a level below the maximum charging rate (˜1 C) recommended for the battery 16. Limiting the charge rate helps to optimize battery life. When the voltage of the battery 16 reaches Vₘₐₓ, the constant-voltage phase (second phase) begins and the charge control device 28 reduces charging current as needed to hold the voltage measured at the terminals of the battery 16 constant at the set point voltage (Vₘₐₓ). Additional protection circuits (voltage and temperature sensors that limit the batteries to Vₘₐₓ+0.10 volt/cell and 90° C.) may be built into the batteries 16, control system 20, or charge control device 28 to shut off charging if these limits are exceeded to prevent overcharging. The use of large stationary storage batteries 32 to recharge batteries 16 in vehicles or EREVs 14 may also have the advantage of fast charging the vehicle at the maximum recommended charge rate instead of the self-regulated rate possible with direct connection to a PV array 12.

In FIG. 9, another embodiment of a charger system 10 is shown that uses solar power generated from a PV array 12 and links that power to a control system 20 to recharge a battery 16, power a hydrogen-producing electrolysis unit/electrolyzer 36, or supply energy to a house, building, or the power grid 22. In this embodiment, PV array 12 can be linked to the control system 20 capable of selectively regulating current to the electrolyzer 36, a stationary storage battery 32, or a building/electric grid 22. When the control system 20 electrically connects the PV array 12 to the stationary storage battery 32, the battery 32 is charged as described above. When the user wishes to charge his vehicle or EREV 14, he electrically links the EREV 14 to the storage battery 32 via the plug 34. In this embodiment, the EREV 14 can be powered by a fuel cell 40 connected to electric motors for propulsion which supply its extended range rather than an internal combustion engine. If the storage battery 32 is fully charged or if the user desires, the control system 20 can be set to electrically connect the PV array 12 with the electrolyzer 36. The electrolyzer 36 uses the principles of electrolysis to disassociate water (H₂O) into diatomic molecules of hydrogen (H₂) and oxygen (O₂). Many types of electrolyzers 36 may be used. Examples include, but are not limited to, alkaline electrolyzers, proton exchange membrane (PEM) electrolyzers, steam electrolyzers, and high-pressure electrolyzers. Electrolyzers 36 generally use a group of individual cells electrically interconnected to obtain a desired rate of hydrogen production using specified electrical power parameters.

The power of the PV array 12 may equal the sum of the power to charge the battery 16 so as to achieve a commuting range of 40 miles/day using only electric energy and also the power to generate enough hydrogen to propel the vehicle 280 miles/week using only hydrogen. In this example, 280 miles/week may be achieved by producing 6 kg hydrogen per week. A pure battery-powered (electric vehicle) range of 40 miles may use 2.4 kW of PV power (Table 1) measured at the maximum power point under typical operating conditions. This power may be equivalent to 2.6 kW at the maximum power point measured under standard test conditions (STC). The additional PV power, as measured under STC, to generate 6 kg of hydrogen/week is 8.5 kW. This calculation assumes a fuel consumption of 21.4 g/mi, an electrolyzer efficiency of 60%, and average daily solar radiation as in Los Angeles equivalent to 5.6 peak sun hours. Power=6 kg×33.35 kWh/kg×1/(0.60×5.6 hours/day×7 days)=8.5 kW

The total power of the PV array 12 that may be used to perform both the battery charging and hydrogen production functions can be 11.1 kW (the sum of the two power ratings: 2.6 kW+8.5 kW). Separate PV arrays 12 for charging a battery 16 and producing hydrogen may function independently while simultaneously collecting energy from the sun to power the vehicle or EREV 14 through both the battery 16 and hydrogen fuel cell components. Therefore, the optimum battery set point and maximum power point of one group of PV cells used for battery charging can be determined independently from the optimum electrolyzer operating voltage and PV maximum power point of another group of PV cells used for hydrogen generation. However, for convenience, the same type of PV cells could be used for both charging the battery 16 and the electrolyzer 36. And the overall system 10 could be designed so that the same maximum power point voltage is used as the battery set point voltage and the operating voltage of the electrolyzer 36. DC-DC converters can also be used in the system 10 for charging the battery 16 and producing hydrogen for the electrolyzer 36 making the voltage match the battery 16 and electrolyzer 36 needs.

Since electrolzyer design may use electrolyzer cells with set voltages, specific hydrogen production rates may be generated using a specific arrangement of electrolyzer cells. In operation, the PV array 12 may be electrically connected via the control system 20 to the electrolyzer 36 which generates hydrogen. The hydrogen then flows to high-pressure hydrogen tanks 38. Once in the tanks 38, the hydrogen can provide fuel for hydrogen fuel cells 40 capable of generating electricity to power EREVs 14 or supply the building/electric grid 22.

It can be appreciated that the hydrogen tanks 38 may be located either in close proximity to a stationary PV array 12 or within an EREV 14. The hydrogen tanks 38 may regulate both the incoming, accumulated, and outgoing hydrogen via high-pressure valves 42. An example of a high pressure valve can include a WEH or Quantum high pressure refueling valve (such as Quantum DV1073) consisting of a manual shut off valve and a pressure relief device (PRD) that may be used to transfer hydrogen from a stationary storage tank 38 to a vehicle storage tank 38 through a connection such as a WEH OPW H₂ filling nozzle (CW 5000, FTI, International Inc.). If the tanks 38 are located in close proximity to the PV array 12, the hydrogen generated by the electrolyzer 36 flows into the tanks 38 where it is stored until an EREV 14 using a fuel-cell powerplant 40 needs to refuel. The fuel cell powerplant 40 can be any fuel cell commonly known that uses hydrogen as a fuel source. When an EREV 14 needs to refuel, the high-pressure tanks 38 may connect to the EREV 14 and a high-pressure valve 42 can regulate hydrogen flowing from the tanks 38 to the EREV 14. The hydrogen may also be used to supply a fuel cell powerplant 40 capable of powering a building or supplying surplus energy to the electric grid 22. It can also be appreciated that the electrolyzer 36 may be linked to high-pressure tanks 38 mounted to an EREV 14. In this embodiment, an EREV 14 may be parked near the electrolyzer 36 and the high-pressure tanks 38 mounted on the EREV 14 are linked to the electrolyzer 36. The electrolyzer 36 generates hydrogen and a high-pressure valve 42 regulates the hydrogen flowing into the tanks 38.

If neither hydrogen production nor battery charging is desired, the PV array 12 may also be electrically linked via the control system 20 to a house or electrical grid 22. When electricity is desired at the house or electrical grid 22, the control system 20 may direct power from the PV array 12 or the stationary battery 32 to the house or grid 22 using an inverter to convert the DC to 120 V, 60 cycle, AC.

The above description of embodiments of the invention is merely exemplary in nature and, thus, variations thereof are not to be regarded as a departure from the spirit and scope of the invention.

What is claimed is:

1. A product comprising:
a vehicle battery capable of being charged using solar energy;
a plurality of photovoltaic cells, arranged in series, parallel, or series and parallel forming an array that produces a self-regulating voltage and current for charging the vehicle battery using solar energy; and
an electrical connection linking the array to the vehicle battery.

2. The product as set forth in claim 1, wherein the vehicle battery is adapted to be removable from the vehicle.

3. The product as set forth in claim 1, wherein the electrical connection includes a switch, and wherein the switch disengages the array from the vehicle battery after the voltage measured at the terminals of the vehicle battery exceeds a first predetermined voltage value.

4. The product as set forth in claim 3, wherein the switch engages the array to the vehicle battery if the voltage measured across the terminals of the vehicle battery falls below a second predetermined voltage value.

5. The product as set forth in claim 1, further comprising a blocking diode or a zener diode that is electrically linked to the vehicle battery.

6. The product as set forth in claim 1, wherein the array produces a maximum power point voltage that substantially equals a set point voltage of the vehicle battery.

7. A product comprising:
a battery capable of being charged with solar energy;
a plurality of photovoltaic cells arranged in series, parallel, or series and parallel according to the voltage and power of each photovoltaic cell, forming an array capable of charging the battery, wherein the voltage and current drawn from the array are controlled by the charge of the battery; and
an electrical connection linking the array to the battery.

8. The product set forth in claim 7, wherein the battery is a vehicle battery adapted to be removed from the vehicle.

9. The product set forth in claim 7, wherein the battery is a stationary battery.

10. The product as set forth in claim 7, further comprising:
an electrolysis unit powered by the array, wherein the electrolysis unit is capable of generating hydrogen;
a hydrogen storage tank for storing the hydrogen generated by the electrolysis unit; and
a control system for selectively directing power from the array to the battery, the electrolysis unit, or to both at the same time.

11. The product as set forth in claim 10, wherein
the optimum operating voltage of the electrolysis unit and the set point voltage of the battery are the same and are equal to the maximum power point voltage of the array.

12. The product set forth in claim 9, further comprising a vehicle battery electrically linked to the stationary battery, wherein the stationary battery applies a charge to the vehicle battery.

13. The product set forth in claim 7, wherein the battery accepts a direct current voltage input greater than 150 volts.

14. The product set forth in claim 12, wherein the capacity of the stationary battery is greater than the capacity of the vehicle battery.

15. The product set forth in claim 12, further comprising:
a first charge control device electrically linking the array with the stationary battery, wherein the first charge control device regulates the voltage and current generated by the photovoltaic cells and conveys the voltage and current to the stationary battery; and
a second charge control device electrically linking the stationary battery and the vehicle battery, wherein the second charge control device regulates the voltage and current generated by the stationary battery and conveys the voltage and current to the vehicle battery.

16. The product set forth in claim 15, wherein the first charge control device and the second charge control device are direct current to direct current converters and further comprise at least one of a solid state inverter, a transformer, or a rectifier.

17. The product set forth in claim 15, wherein the vehicle battery is linked to the second charge control device via a plug attached to a vehicle.

18. The product set forth in claim 15, wherein the first charge control device regulates the voltage and current applied to the stationary battery by sensing that the voltage of the stationary battery is below the set point voltage of the stationary battery and increasing the current applied to the stationary battery.

19. The product set forth in claim 15, wherein the first charge control device regulates the voltage and current applied to the stationary battery by sensing that the stationary battery voltage is above a stationary battery set point voltage and reducing the amount of current applied to the stationary battery and holding the stationary battery voltage substantially constant.

20. The product set forth in claim 15, wherein the second charge control device regulates the voltage and current applied to the vehicle battery by sensing that the voltage of the vehicle battery is below the set point voltage of the vehicle battery and increasing current applied to the vehicle battery.

21. The product set forth in claim 15, wherein the second charge control device regulates the voltage and current applied to the vehicle battery by sensing that the voltage of the vehicle battery is above a set point voltage of the vehicle battery and reducing the amount of current applied to the vehicle battery and holding the voltage of the vehicle battery substantially constant.

22. A product comprising:
a plurality of photovoltaic cells, arranged in series, parallel, or series and parallel forming an array that produces a self-regulating voltage and current for charging the vehicle battery using solar energy;
a first battery capable of storing electric energy generated by the plurality of photovoltaic cells, wherein the first battery is substantially stationary;
a first link electrically connecting the plurality of photovoltaic cells and conveying the self-regulating voltage and current from the plurality of photovoltaic cells to the first battery;
a second battery mounted on a vehicle capable of receiving charge from the first battery; and
a second link electrically connecting the first battery and the second battery, wherein the first battery applies a charge to the second battery through the second link.

23. The product as set forth in claim 22, wherein the second battery is adapted to be removable from the vehicle.

24. The product as set forth in claim 22, wherein the first link includes a switch, and wherein the switch disengages the array from the first battery after the voltage measured at the terminals of the first battery exceeds a first predetermined voltage value.

25. The product as set forth in claim 24, wherein the switch engages the array to the first battery if the voltage across the terminals of the first battery falls below a second predetermined voltage value.

26. The product as set forth in claim 22, wherein the second link includes a switch, and wherein the switch disengages the first battery from the second battery after the voltage measured at the terminals of the second battery exceeds a first predetermined voltage value.

27. The product as set forth in claim 26, wherein the switch engages the first battery to the second battery if the voltage measured across the terminals of the second battery falls below a second predetermined voltage value.

28. The product as set forth in claim 22, wherein the array produces a maximum power point voltage that substantially equals a set point voltage of the first battery.

29. The product set forth in claim 22, further comprising a charge control device connecting the array with the first battery.

30. The product set forth in claim 22, further comprising a charge control device connecting the first battery with the second battery.

31. The product as set forth in claim 29, wherein the charge control device is a direct current to direct current converter and further comprises at least one of a solid state inverter, a transformer, or a rectifier.

32. The product as set forth in claim 29, wherein the charge control device uses sensors capable of monitoring the first battery to provide input to a charge regulator controlling the charge rate and set point of the vehicle battery.

33. A product comprising:
an array of photovoltaic cells capable of charging a battery arranged in series, parallel, or series and parallel according to the voltage and power of each photovoltaic cell, wherein the array produces a maximum power point voltage that substantially equals a set point voltage of the vehicle battery;
a first battery remaining in a substantially stationary position capable of receiving a charge from the array;
a second battery mounted in a vehicle capable of receiving a charge from the first battery;
an electrolyzer for producing hydrogen, wherein the hydrogen is stored in tanks adjacent to the electrolyzer or on the vehicle; and
a control system for selectively directing the energy generated by the array to the first battery, the second battery, the electrolyzer, or an electric grid.

34. A method comprising:
(a) determining a set point voltage of a vehicle battery;
(b) calculating a photovoltaic power to charge the vehicle battery;
(c) establishing the number of photovoltaic cells to be electrically connected in series by determining maximum power point voltage per photovoltaic cell and dividing the set point voltage by the maximum power point voltage per photovoltaic cell;
(d) establishing the number of photovoltaic cells to be electrically connected in parallel by determining the photovoltaic power per cell and dividing the photovoltaic power by the photovoltaic power per cell;
(e) arranging a plurality of photovoltaic cells in an array according to the established number of photovoltaic cells in series and the established number of photovoltaic cells in parallel; and
(f) electrically linking the array to the vehicle battery in order to charge the vehicle battery to the set point voltage using solar energy.

35. A method comprising:
(a) determining a set point voltage of a vehicle battery;
(b) determining an operating voltage of an electrolysis system;
(c) calculating a photovoltaic power for charging the vehicle battery and generating hydrogen; and
(d) forming an array of photovoltaic cells arranged in series, parallel, or series and parallel according to the set point voltage of the vehicle battery and the operating voltage of an electrolysis system.

36. The method of claim 35 wherein step (d) further comprises:
(i) determining a maximum power point voltage per photovoltaic cell;
(ii) establishing the number of photovoltaic cells electrically connected in series by dividing the sum of the set point voltage of the vehicle battery and the operating voltage of the electrolysis system by a maximum power point voltage per photovoltaic cell;
(iii) establishing the number of photovoltaic cells to be electrically connected in parallel by determining a photovoltaic power per cell and dividing the sum of the photovoltaic power required to charge the battery and operate the electrolysis system by the photovoltaic power per cell;
(iv) arranging a plurality of photovoltaic cells in the array according to steps (ii) and (iii); and
(v) electrically linking the array to the vehicle battery and the electrolyzer.
